(19) United States
(12) Patent Application Publication
(10) Pub. No.: US 2006/0006974 A1
(43) Pub. Date: Jan. 12, 2006

(54) [TRANSFORMER MODULE]

(75) Inventors: Ching-Sheng Yang, TAIPEI (TW); Su-Hua Wu, TAIPEI (TW); Shu-Chen Wang, TAIPEI (TW); Chien-Ming Lin, TAIPEI (TW)

Correspondence Address: TAIPEI MULTIPOWER ELECTRONICS CO., LTD., 2F-4, NO. 148, SEC. 4, CHUNG HSIAO EAST ROAD, TAIPEI, TW

(73) Assignee: TAIPEI MULTIPOWER ELECTRONICS CO., LTD., Hsin-Tien City, Taipei Hsien (TW)

(21) Appl. No.: 10/710,406

(22) Filed: Jul. 8, 2004

(51) Int. Cl. H01F 27/30

(52) U.S. Cl. 336/208

(57) ABSTRACT

A transformer module having an external transmission element capable ofreducing interferences between adjacent transformers, comprising at least a bobbin, enclosing a hollow central region and comprising a receiving hole, wherein two sides of said bobbin comprises an inlaying portion and a buckling portion, and wherein a plurality of terminals extend from said buckling portion; a core element, positioned inside said receiving hole of said bobbin, wherein two ends of said core element protrude out of said inlaying portions of said bobbin; and a transmission element, comprising a holding portion at two sides thereof, wherein said transmission element is secured at said inlaying portion of said bobbin by inlaying said holding portion of the transmission element into said inlaying portion of said bobbin and thereby electrically connecting said transmission element with said core element to conduct and stabilize a magnetic field.

### BACKGROUND OF INVENTION

1. The Field of the Invention

The present invention relates to a transformer module, and more particularly, to a transformer module comprising at least a base comprising an external transmission element for reducing electromagnetic interference and as well as stabilize the magnetic field.

2. Description of Related Art

Transformer is an essential component of electronic appliances. The main purpose of the transformer is to transform the driving voltage for the electronic circuit. The mode and type of the transformer may vary according to various requirements, for example, a high voltage transformer is applied for raising the operation voltage of a TV monitor and a power supply transformer is applied for decreasing the voltage output from the power plant, and so on. Transformers are designed in various specifications and types accordingly the types of appliances. The conventional transformer has copper coil wound around a central hollow portion of a bobbin, and the coil is covered by an isolation layer having other layer of copper coil surrounding it thus forming the main coil of the transformer. Two core elements are positioned symmetrically at the hollow portion of the center of the bobbin, and the bobbin has the transmission terminals positioned at the two sides thereof, wherein the input terminal is set at a distal end thereof, and the output terminal is set at the primal end thereof. The rounds of the coil on the bobbin relates to the transformation of voltage, therefore the performance of transforming of the conventional transformer is fixed and do not allow further expansion of transforming capacity. Accordingly, the interference and unstable voltage can easily occur.

Referring to FIGS. 11, 12 and 13, the first bobbin A is a hollow tubular structure having bottom plates A1 and A2 extended at the two ends respectively, and the bottom plates A1 and A2 have a plurality of terminals A3 and A4 at end portion thereof.

The second bobbin B is a hollow tubular structure having bottom plates B1 and B2 extended at the two ends respectively, and the bottom plates B1 and B2 have a plurality of terminals B3 and B4 at end portions thereof. The second bobbin B is positioned against the first bobbin A.

At least a copper wire C is wounded around the first bobbin A and the second bobbin B, and the distal end of the copper wire C joints to the plurality of terminals A3, A4 of the first bobbin A and B3, B4 of the second bobbin B to form the electrical signal terminals of the first side D2 and the second side D1 of the transformer D.

Two core elements E are positioned symmetrically and are assembled in a U shape. One of the core elements E has two parallel bars E1, E2 joint to a side piece E5 at the primal ends thereof. The other metallic core E also has two parallel bars E3, E4 joint with a side piece E6 at the primal ends thereof. The two core elements E have bars E1, E2, E3 and E4 that can be penetrated into the central hollow portion of the first bobbin A and the second bobbin B, and the bars E1, E2, E3 and E4 and the side piece E5 and E6 formed the loops that interference with each other.

The above conventional transformer module has at least the following defects.

1. The side piece E5 joints with the two bars E1 and E2 and the side piece E6 joints with the two bars E3 and E4 of the two core elements E, thus the magnetic fields of the E5 and E6 cross over each other in the first bobbin A and the second bobbin B and thereby interfere with each other.

2. The first bobbin A and the second bobbin B joint together to form the transformer D, and when the voltages are input from the first side D2 and output through the second side D1, the current value output from terminal A3 of the first bobbin A and the terminal B3 of the second bobbin B will not be consistent and are imbalanced.

3. The first bobbin A and the second bobbin B comprise two core elements E that can be inserted symmetrically for transferring voltage, and the connection between the bars E1, E2, E3 and E4 of the core elements E can cause electromagnetic interference.

The above defects of the conventional transformer are important issues for the manufacturers of the field to improve.

### SUMMARY OF INVENTION

Accordingly, in the view of the foregoing, the present inventor makes a detailed study of related art to evaluate and consider, and uses years of accumulated experience in this field, and through several experiments, to create a new converting circuit for allowing increased error bytes tolerance and thereby prevent the error correction code error from occurring due to the byte correction rule.

According to an aspect of the present invention, the transformer module comprises a bobbin, a core element and a transmission element. The bobbin is a tubular structure with a hollow central portion and a receiving hole for receiving the core element. The two sides of the bobbin have an inlaying portion and a buckling portion and the holding portion of the transmission element can be buckled to the inlaying portion positioned at the two sides of the bobbin and electrical connected to the core element positioned inside the bobbin. The structure of the transformer module of the present invention is capable of stabilizing the voltage while conducting.

According to another aspect of the present invention, the transmission element is made of a conductive material and comprises a protruded holding portion at two sides for buckling to the inlaying portion of the bobbin.

According to another aspect of the present invention, the buckling portions at two sides of the bobbin comprise a buckling element and a buckling groove such that the buckling element of an adjacent bobbin can be buckled into the buckling groove of the base to securely join the two bobbins.

### BRIEF DESCRIPTION OF DRAWINGS

For a more complete understanding of the present invention, reference will now be made to the following detailed description of preferred embodiments taken in conjunction with the following accompanying drawings.

FIG. 1 is an elevational view of a transformer module according to an embodiment of the present invention.

FIG. 2 is an exploded view of a transformer module according to an embodiment of the present invention.

FIG. 3 is a bottom view of a bobbin of a transformer module according to an embodiment of the present invention.

FIG. 4 is an exploded view showing the positioned bobbins of the transformer module according to an embodiment of the present invention.

FIG. 5 is an exploded view of a core element penetrating into the bobbin of the transformer module according to an embodiment of the present invention.

FIG. 6 is an elevational view of inlaying a transmission element into the bobbin of the transformer module according to an embodiment of the present invention.

FIG. 7 is an exploded view of a transformer module according to an embodiment of the present invention.

FIG. 8 is an exploded view of a transformer module according to an embodiment of the present invention.

FIG. 9 is an exploded view of a transformer module according to another embodiment of the present invention.

FIG. 10 is an exploded view of a transformer module according to another embodiment of the present invention.

FIG. 11 is an exploded view of a conventional transformer.

FIG. 12 is an exploded view of an assembly of the conventional transformer.

FIG. 13 is an elevational view of a conventional transformer.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

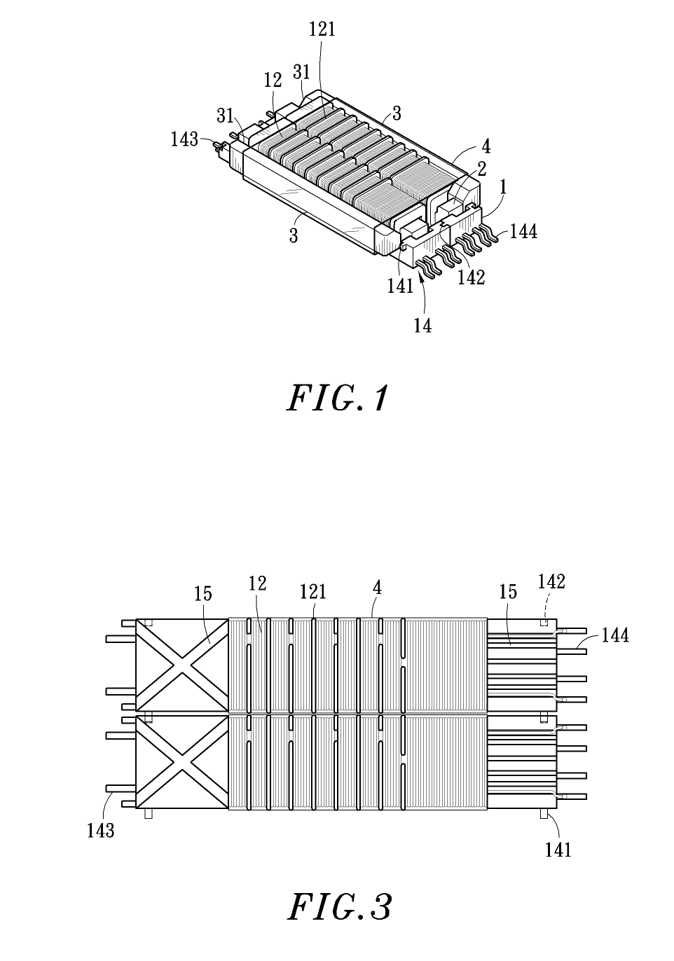

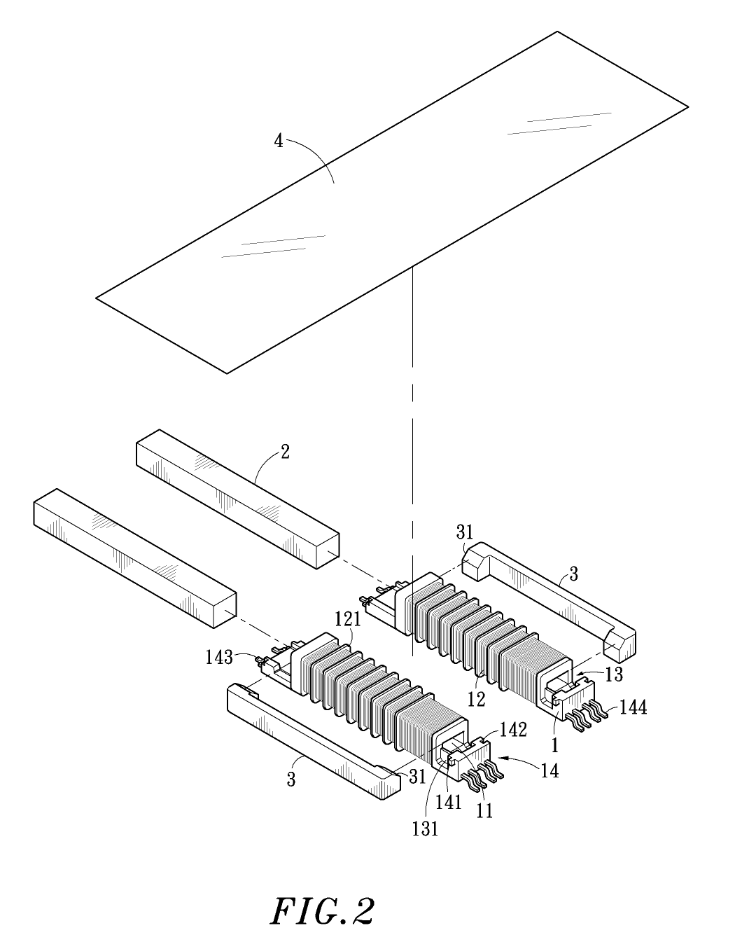

Referring to FIGS. 1, 2 and 3, the transformer module, according to an embodiment of the present invention comprises a bobbin 1, a core element 2 and a transmission element 3.

The bobbin 1 is a tubular structure with a hollow central region and has a receiving hole 11. A copper coil 12 is wounded around the bobbin 1 and a plurality of partitions 121is disposed between each layer of the coil 12. At the two sides of the bobbin 1 comprise an inlaying portion 13 and a buckling portion 14. The inlaying portion 13 comprises an inlaying groove 131 at two sides thereof. The buckling portion 14 comprises a buckling element 141 and a buckling groove 142, and a plurality of extended terminals 143 and 144 extend from a side of the buckling portion 14, wherein the extended terminals 143 and 144 are electrically connected to the coil 12 by a guiding groove 15 positioned at a bottom of the bobbin 1.

The core element 2 is a long bar made of a conductive material.

The transmission element 3 is made of a conductive material and comprises a protruded buckling portion 31 at two sides thereof.

The above core element 2 can be penetrated into the receiving hole 11 of the bobbin 1 such that two ends of the core element 2 protrude out of the inlaying portion 13 at two sides of the bobbin 1. The transmission element 3 is secured at the inlaying portion 13 of the two sides of the bobbin 1 by inlaying the inlaying portion 31 into the inlaying groove 131 of the inlaying portion 13, and thus an electrical connection between the holding portion 31 of the transmission element 3 and the core element 2 positioned at the inlaying portion 13 is established to form a magnetic loop. Thus, the assembly of the transformer module is completed.

The bobbin 1 of the transformer module can be coated by an isolative film 4 for protecting the coil 12 around the bobbin 1.

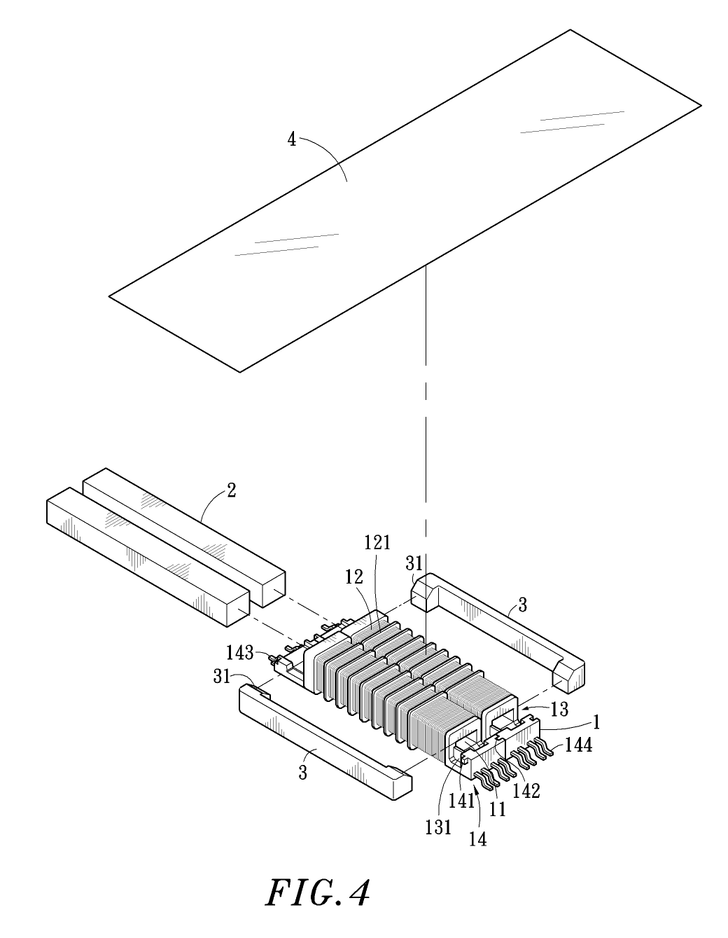

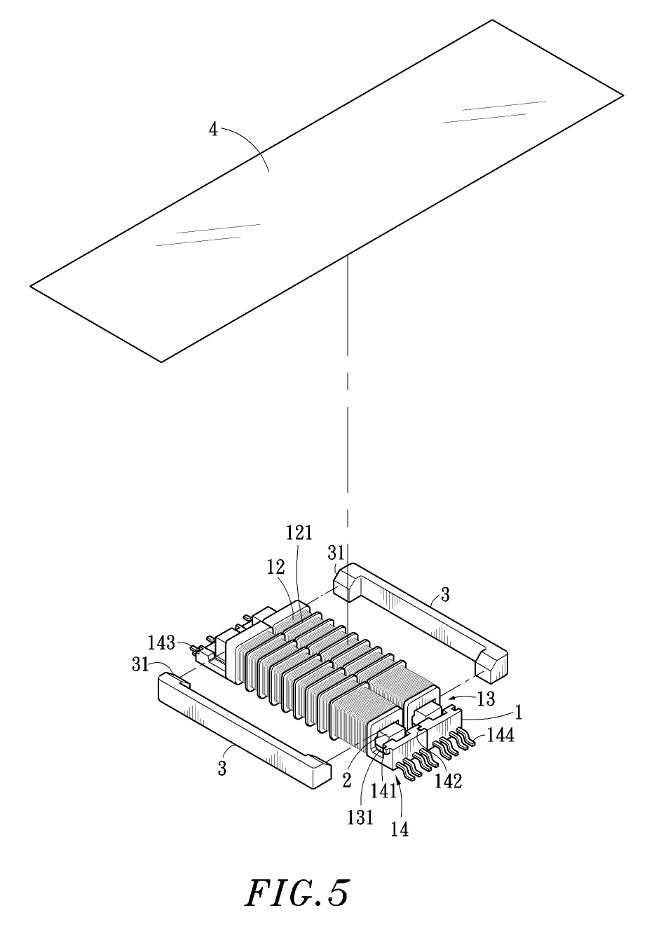

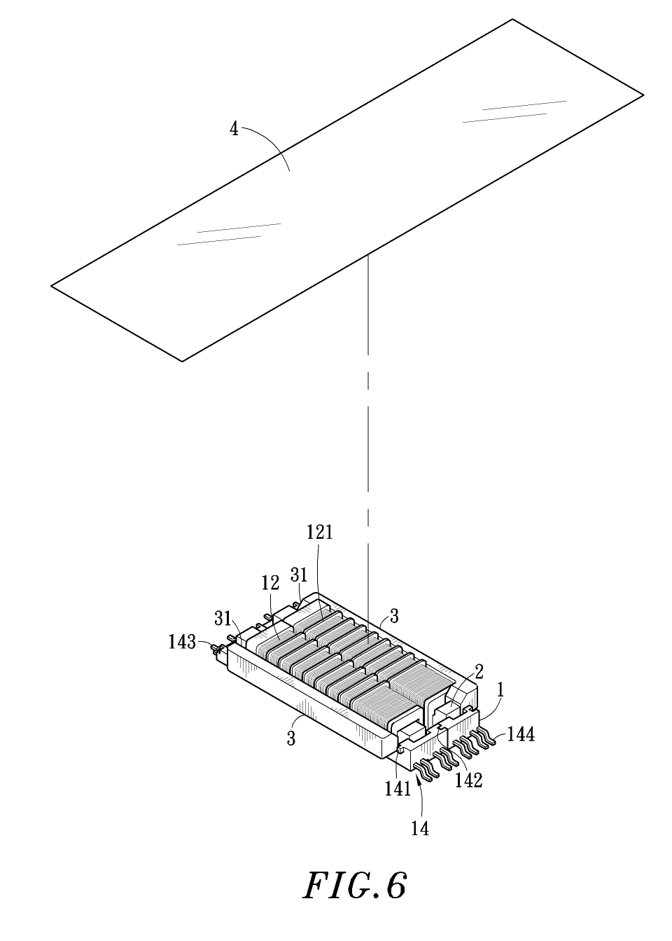

Referring to FIGS. 4, 5 and 6, one of the buckling portions 14 of the bobbin 1 comprises the buckling element 141 and the buckling groove 142 at two sides thereof for buckling to the buckling element 141 and the buckling groove 142 of the buckling portions 14 of the other base 1 for positioning the two bobbins 1 securely. Thus, the bobbins 1 can be jointed together securely. Furthermore, the two core elements 2 can be penetrated into the receiving holes 11 of the bobbins 1 respectively such that two ends of the core elements 2 protrude out of the inlaying portions 13 at two sides of the bobbins 1. The transmission elements 3 are secured at the inlaying portions 13 of the two outsides of the bobbins 1 by inlaying the holding portions 31 into the inlaying grooves 131 of the inlaying portions 13, and thus an electrical connection between the inlaying portions 31 of the transmission elements 3 and the core elements 2 positioned at the inlaying portions 13 are established to form a magnetic loop. The above two transmission elements 3 do not have electrical contact with each other, and therefore there is no interference between each other, thus the electrical signal transmission is more stable.

The bobbin 1 can be coated by the isolative film 4 to protect the surrounding coil 12 from air or dust.

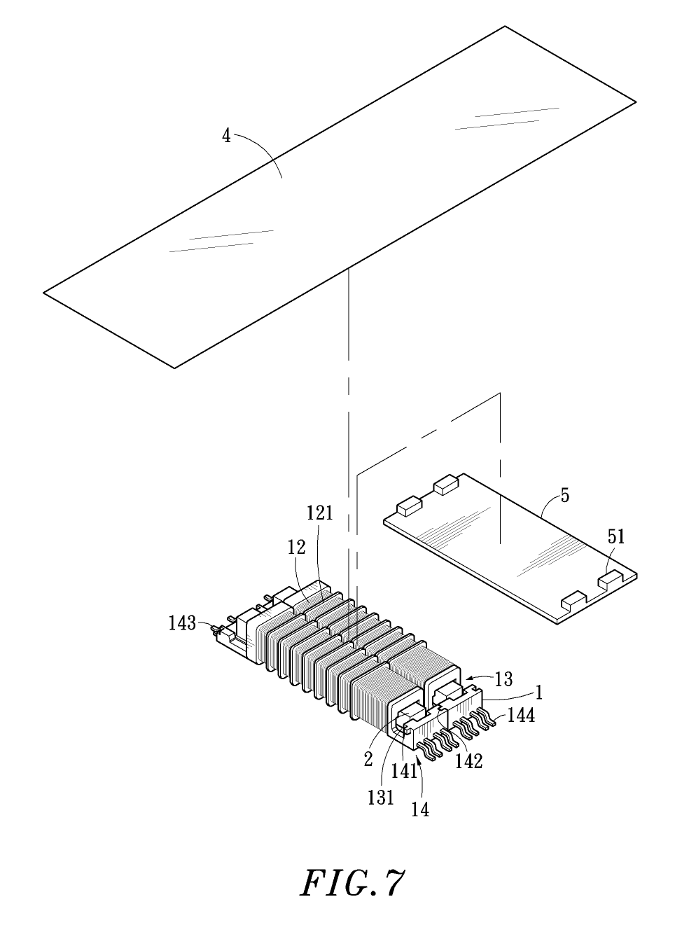

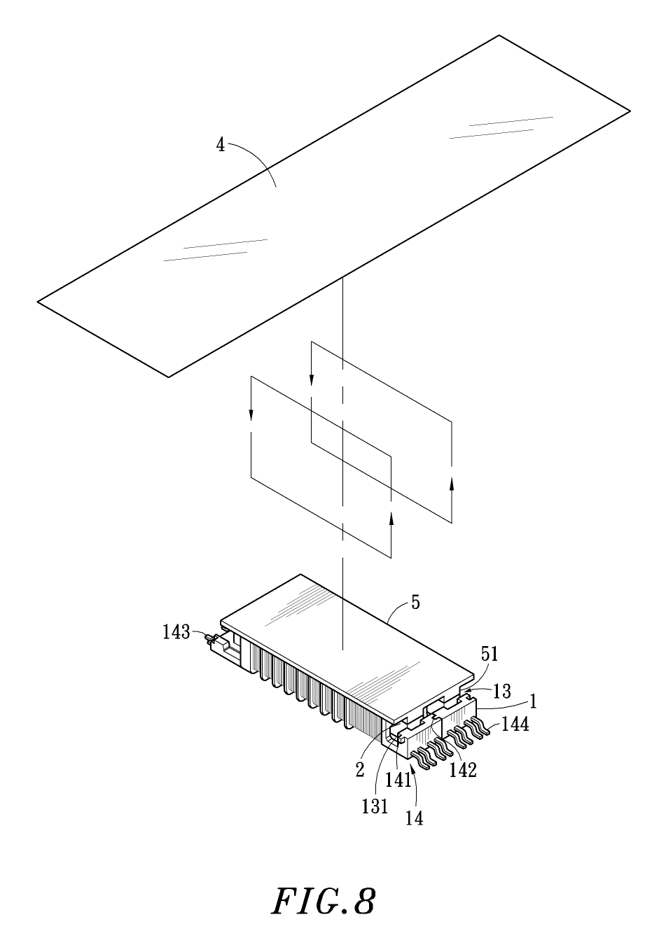

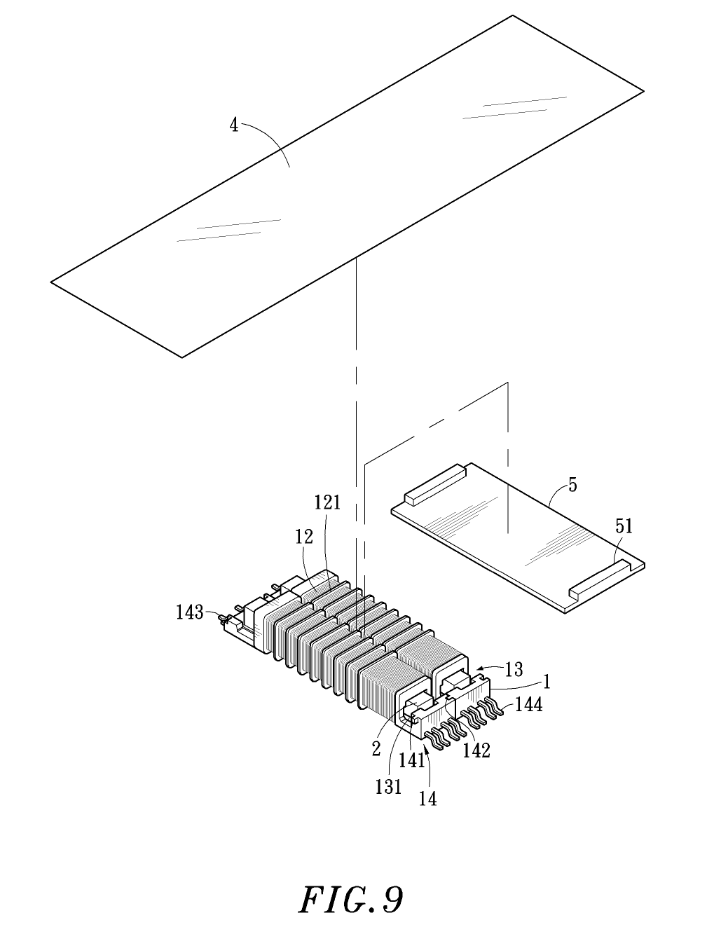

Referring to FIGS. 7, 8 and 9, the core element 2, according to an embodiment of the present invention, is penetrated into the receiving hole 11 of the bobbin land then the bobbin 1 is covered by a lid 5. The lid 5 comprises a plurality of jointing portions 51 at corresponding sides to make electrical contact with the core element 2 of the bobbin 1 for forming the magnetic loop in order to stabilize the electrical signal transmission. The jointing portions 51 of the lid 5 can be an formed on the lid 5 as separate elements as shown in FIG. 7 or as a long bar as shown in FIG. 9 for making electrical connection with the core element 2.

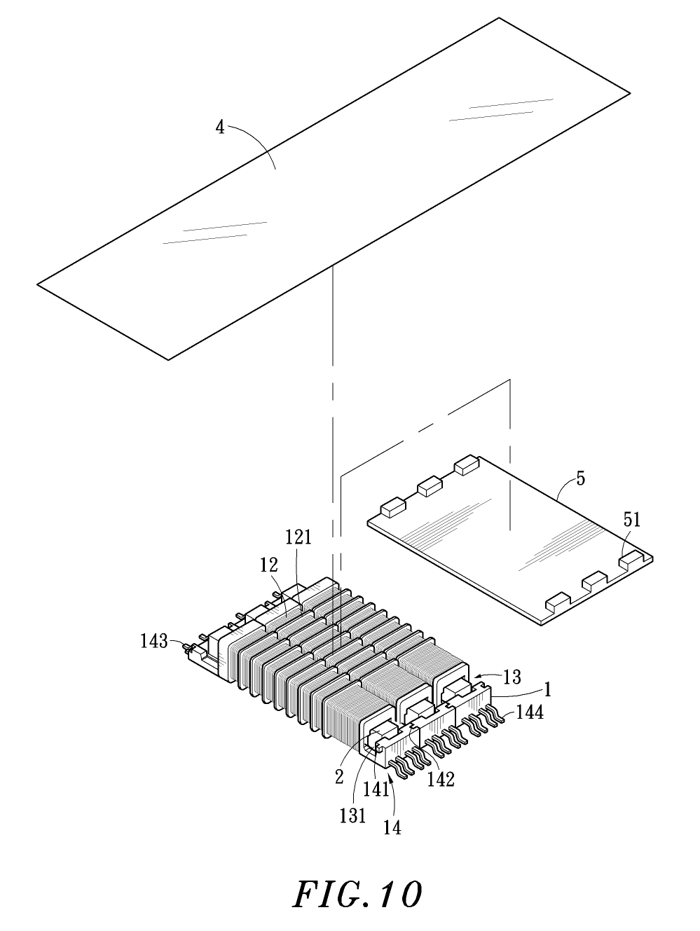

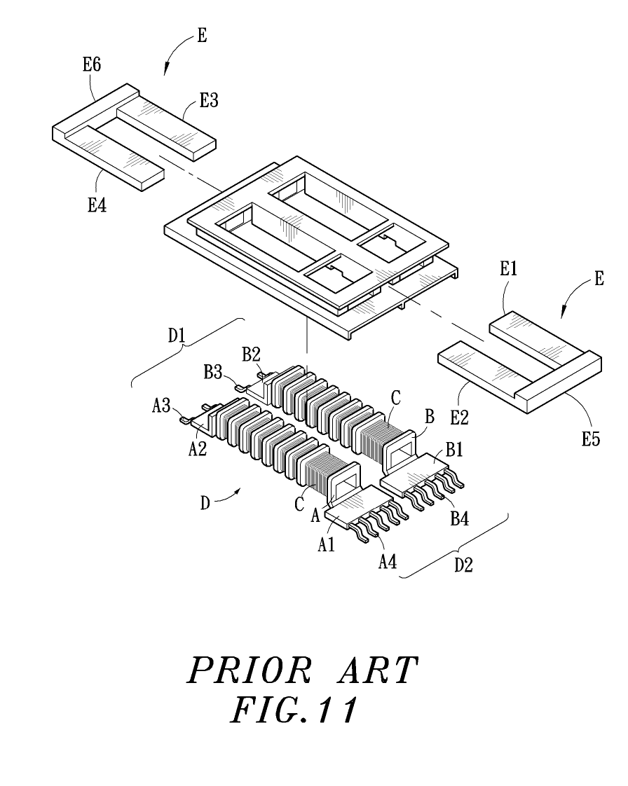

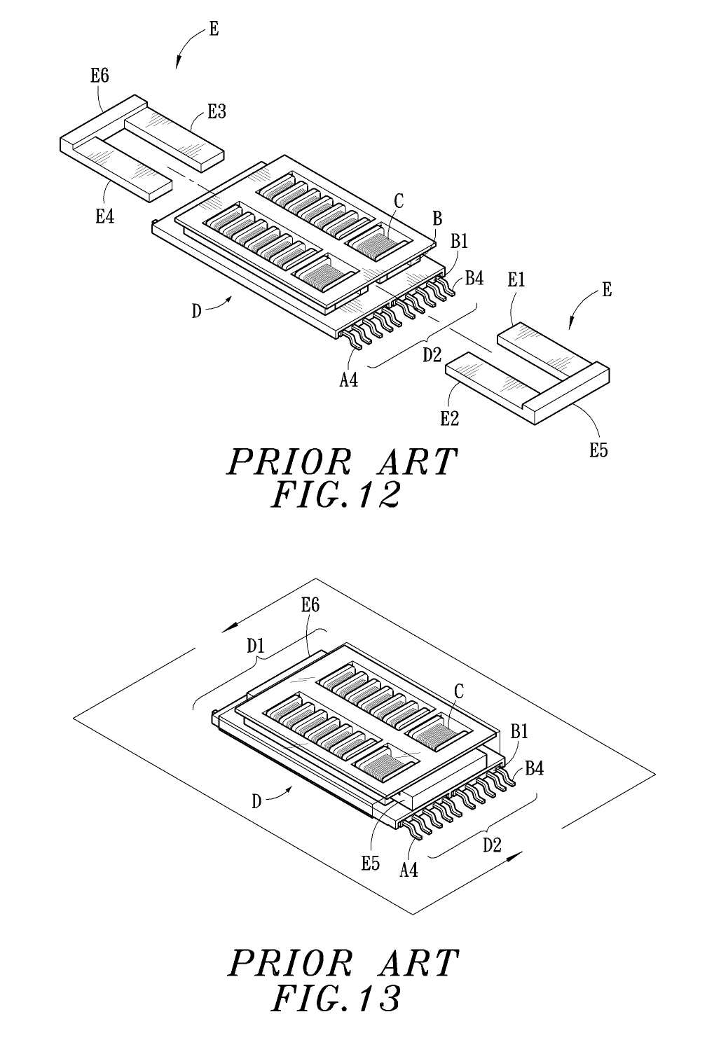

Referring to FIG. 10, an exploded view of a transformer module according to another embodiment of the present invention is shown. The transformer module comprises a plurality of bobbins 1 and by buckling the buckling element 141 of the buckling portion 14 of a bobbin 1 into the buckling groove 142 of an adjacent bobbin 1, the two bobbins 1 can be jointed together and the top of the bobbins 1 is covered by the lid 5. The lid 5 comprises a plurality of jointing portions 51 at a side thereof to make electrical contact with the core element 2 positioned at the inlaying portion 13 of the bobbin 1 in order to allow every bobbin 1 to process electrical signal transmission via the jointing portions51 of the lid 5 and form the magnetic loop. Finally, the bobbin 1 can be coated with the isolative film 4 to complete the assembly of the transformer module.

Accordingly, the transformer module of the present invention has at least the following advantages.

1. The bobbin of the transformer module comprises different transmission elements to make electrical connection and the magnetic loop in order to reduce electromagnetic interference.

2. The bobbin of the transformer module can form different loops to form a uniform magnetic field.

3. The bobbin of the transformer module can form different loops, therefore the voltage transformed can be more stable and the output current value will be consistent.

4. The transformer module comprises a plurality of bases having different transmission elements, and therefore interference of the electrical signal can be effectively reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1-9. (canceled)

10. A transformer module, comprising:
at least two bobbins, each bobbin enclosing a hollow central region and comprising a receiving hole, wherein two sides of each bobbin comprises an inlaying portion and a buckling portion, and wherein a plurality of terminals extend from said buckling portion, wherein said buckling portion at two sides of each bobbin comprise a buckling element and a buckling groove respectively, and wherein said buckling element of one of said bobbins is buckled to said buckling groove of another bobbin of said bobbins;
a core element, positioned inside said receiving hole of each bobbin;
two transmission elements, two end portions thereof electrically connected with two end portions of said core elements respectively, wherein said transmission element is secured at said inlaying portion of each bobbin by inlaying a holding portion of the transmission element into said inlaying portion of each bobbin; and
a lid, covering a top of said bobbins, electrically connected to said transmission element.

11. The transformer module according to claim 10, wherein said lid comprises a plurality of jointing portions at sides thereof.

12. The transformer module according to claim 11, wherein said jointing portions formed at sides of said lid comprises long bars.

13. The transformer module according to claim 10, wherein said transmission elements are made of a conductive material.

14. (canceled)

15. The transformer module according to claim 10, wherein said transmission elements are positioned independently.

16. The transformer module according to claim 10, wherein said inlaying portion formed at two sides of said bobbins comprises an inlaying groove respectively.

17. A transformer module, comprising:
at least two bobbins, each bobbin enclosing a hollow central region and comprising a receiving hole;
a core element, positioned inside said receiving hole of each bobbin;
two transmission elements, two end portions thereof electrically connected with two end portions of said core elements respectively, and
a lid, covering a top of said bobbins, electrically connected to said transmission elements.

18. The transformer module according to claim 17, wherein two sides of each bobbin comprises an inlaying portion and a buckling portion, and wherein a plurality of terminals extend from said buckling portion,

19. The transformer module according to claim 18, wherein said buckling portion at two sides of each bobbin comprise a buckling element and a buckling groove respectively, and wherein said buckling element of one of said bobbins is buckled to said buckling groove of another bobbin of said bobbins, wherein said transmission elements are secured at said inlaying portion of each bobbin respectively by inlaying a holding portion of the transmission elements into said inlaying portion of the bobbins.

20. The transformer module according to claim 18, wherein said inlaying portion formed at two sides of said bobbins comprises an inlaying groove respectively.

21. The transformer module according to claim 17, wherein said lid comprises a plurality of jointing portions at sides thereof.

22. The transformer module according to claim 21, wherein said jointing portions formed at sides of said lid comprises long bars.

23. The transformer module according to claim 17, wherein said transmission elements are made of a conductive material.

24. The transformer module according to claim 17, wherein said transmission elements positioned inside bobbins are positioned independently.
